(19) United States
(12) Patent Application Publication
(10) Pub. No.: US 2009/0012744 A1
(43) Pub. Date: Jan. 8, 2009

(54) System and Method for Statistically Evaluating the Operation of Integrated Circuit Fabrication Tools

(75) Inventor: John R. Booher, Corinth, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/772,876

(22) Filed: Jul. 3, 2007

(51) Int. Cl. G06F 17/18

(52) U.S. Cl. 702/179

(57) ABSTRACT

For use with a manufacturing facility that carries out a plurality of processes, including a test process, to manufacture products, a plurality of alternative, equivalent tools being associated with each of the plurality of processes, a statistical evaluation system and a method of statistically evaluating the manufacturing facility. In one embodiment, the system includes: (1) a random test yield data selector configured to select test yield data on products subjected to a complete distribution randomly from the tools associated with the test process, (2) a group and grand means calculator associated with the random test yield data selector and configured to calculate group and grand means for the selected test yield data and (3) an analysis-of-means representation generator associated with the group and grand means calculator and configured to generate an analysis-of-means representation of at least one of the plurality of processes by plotting the group and grand means and decision limits corresponding to specific significance levels.

### TECHNICAL FIELD OF THE INVENTION

The invention is directed, in general, to manufacturing and, more particularly, to a system and method for statistically evaluating the operation of integrated circuit fabrication tools.

### BACKGROUND OF THE INVENTION

Manufacturing products can be a complex undertaking. A major manufacturing facility is often quite large and houses many different types of manufacturing equipment, frequently called “tools,” which are spread out over what may be a large manufacturing floor. A production line for a given product may involve tens or even hundreds of processes carried out in a defined order with these tools. For example, a digital light processor (DLP) must undergo many hundreds of processes before it is fully fabricated.

To increase production and guard against “line down” time, larger manufacturing facilities often use multiple equivalent tools (tools capable of performing the same process). To ensure that manufacturing defects are discovered as early in the manufacturing process as possible, manufacturing facilities also employ test tools designed to perform tests on products after they have been completed or at certain intermediate stages of completion.

Large manufacturing facilities often make more than one type of product and therefore have more than one production line. Complex production lines may span multiple buildings in various locations. The multiple production lines almost inevitably employ different numbers of processes in different orders, and while certain tools may be common to multiple production lines, some tools may be unique to a certain production line. It is therefore evident that operating a large, multiproduct manufacturing facility can be a highly complex undertaking, even when all of the tools are functioning properly. Unfortunately, tools routinely malfunction even when stringent efforts are made to keep them repaired and operating according to specification.

The efficacy of a tool is typically measured in terms of “yield.” “Process yield” is the raw number or fraction of successfully processed products that emerge from a tool. “Test yield” is the raw number or fraction of products that pass the tests performed by a test tool. “Scrap” refers to products that are not successfully processed. The performance of any tool may be objectively evaluated using yield as the metric.

Tool malfunctions that result in rejected products decrease yield. The severity of the “line down” time that results from a malfunction depends upon the number of equivalent tools that remain functional and the amount of time required to repair the tool that is malfunctioning. Unfortunately, merely identifying the malfunctioning tool often proves difficult. This is especially so when the tool is out of calibration, but within control limits set for its operation. As a result, the malfunction does not affect the apparent process yield of the malfunctioning tool or subsequent, non-test tools, but instead manifests itself in a test yield. In such case, isolating the malfunction to one or a small number of tools (called “segmentation”), becomes vital to addressing the malfunction quickly and restoring the line.

Modern statistical process control techniques rely on the yield of each tool to recognize and attempt to isolate tool malfunctions. These systems have performed well for many years. But as long as scrap continues to be generated, the possibility for improvement remains.

What is needed in the art is a system for, and method of statistically evaluating the operation of a manufacturing facility such that malfunctioning tools can be identified more quickly, more effectively and perhaps by people not accustomed to interpreting statistical charts. What is further needed in the art is a system for statistically evaluating a semiconductor fabrication facility (which certainly qualifies as a complex manufacturing facility) such that its yield may be enhanced.

### SUMMARY OF THE INVENTION

Various embodiments of the invention have as their workpiece a manufacturing facility that carries out a plurality of processes, including a test process, to manufacture products. A plurality of alternative, equivalent tools is associated with each of the plurality of processes.

To address the above-discussed deficiencies of the prior art, the invention provides, in one aspect, a statistical evaluation system. In one embodiment, the system includes: (1) a random test yield data selector configured to select test yield data on products subjected to a complete distribution randomly from the tools associated with the test process, (2) a group and grand means calculator associated with the random test yield data selector and configured to calculate group and grand means for the selected test yield data and (3) an analysis-of-means (ANOM) representation generator associated with the group and grand means calculator and configured to generate an ANOM representation of at least one of the plurality of processes by plotting the group and grand means and decision limits corresponding to specific significance levels.

Another aspect of the invention provides a method of statistically evaluating the manufacturing facility. One embodiment includes: (1) selecting test yield data on products subjected to a complete distribution randomly from the tools associated with the test process, (2) calculating group and grand means for the selected test yield data and (3) generating an ANOM representation of at least one of the plurality of processes by plotting the group and grand means and decision limits corresponding to specific significance levels.

In yet another aspect of the invention, the workpiece is a semiconductor fabrication facility, and its products therefore are integrated circuits (ICs). One embodiment includes: (1) a random test yield data selector configured to select test yield data on ICs subjected to a complete distribution randomly from the tools associated with the test process, (2) a test yield data bias corrector associated with the random test yield data selector and configured to reduce at least some bias in the test yield data, (3) a test yield data normalizer associated with the test yield data bias corrector and configured to normalize the test yield data, (4) a group and grand means calculator associated with the random test yield data selector and configured to calculate group and grand means for the selected test yield data and (5) an ANOM representation generator associated with the group and grand means calculator and configured to generate an ANOM representation of at least one of the plurality of semiconductor fabrication processes by plotting bars for the group means, a line for the grand means and lines for decision limits corresponding to specific significance levels.

The foregoing has outlined certain aspects and embodiments of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiments as a basis for designing or modifying other structures for carrying out the same purposes of the invention. Those skilled in the pertinent art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawings, in which:

FIG. 1 illustrates a diagram of an exemplary manufacturing facility and one embodiment of a statistical evaluation system constructed according to the principles of the invention;

FIG. 2 illustrates a high-level block diagram of one embodiment of the statistical evaluation system of FIG. 1;

FIG. 3 illustrates a flow diagram of one embodiment of a method of statistically evaluating a manufacturing facility carried out according to the principles of the invention;

FIG. 4 illustrates one embodiment of an ANOM representation of at least one of a plurality of processes in which at least one possible tool malfunction is indicated; and

FIG. 5 illustrates one embodiment of an ANOM representation of at least one of a plurality of processes in which tools appear to be functioning properly.

### DETAILED DESCRIPTION

As stated above, merely identifying a malfunctioning tool often proves difficult. This is especially so when the tool is out of calibration, but within control limits set for its operation; the malfunction does not affect the apparent process yield of the malfunctioning tool or subsequent, non-test tools, but instead manifests itself in the test yield resulting from a subsequent test. Statistical process control techniques that rely on process yield as at least one of their metrics will not recognize such a malfunction, because control limits are not being exceeded. In contrast, the invention employs the test yield itself to segment the production line and thus isolate the malfunction to one or a small number of tools. Several embodiments that operate in accordance with the principles of the invention will now be described.

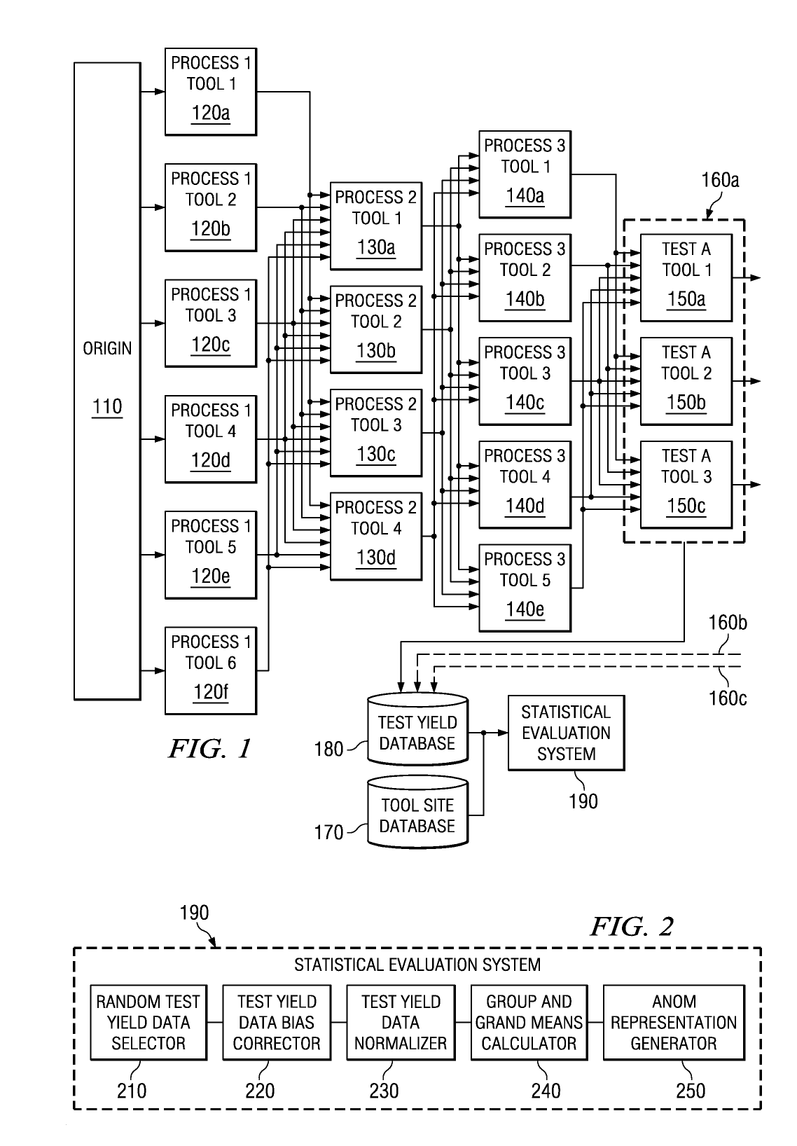

FIG. 1 illustrates a diagram of an exemplary manufacturing facility and one embodiment of a statistical evaluation system constructed according to the principles of the invention. An example production line is illustrated having an origin 110, a first process (“Process 1”) carried out by six equivalent tools (Tool 1 120a, Tool 2 120b, Tool 3 120c, Tool 4 120d, Tool 5 120e, Tool 6 120f), a second process (“Process 2”) carried out by four equivalent tools (Tool 1 130a, Tool 2 130b, Tool 3 130c, Tool 4 130d), a third process (“Process 3”) carried out by five equivalent tools (Tool 1 140a, Tool 2 140b, tool 3 140c, Tool 4 140d, Tool 5 140e) and a test process (“Test A”) carried out by three equivalent test tools (Tool 1 150a, Tool 2 150b, Tool 3 150c). The Tool 1 150a, the Tool 2 150b and the Tool 3 150c generate test yield data as the production line operates. The test yield data are gathered (as represented by a broken-line ellipse 160a) and transmitted to a test yield database 180, where they are stored.

The example product line continues, as the three arrows extending toward the right from the Tool 1 150a, the Tool 2 150b and the Tool 3 150c imply. FIG. 1 assumes that two additional test processes are carried out by subsequent tools (not shown). The test yield data these tools generate are gathered and transmitted as well to the test yield database 180. Broken-line arrows 160b, 160c represent the flow of these test yield data.

A tool site database 170 contains data pertaining to the location of each tool, including the tools 120a-f, 130a-d, 140a-e, 150a-c and perhaps environmental factors that may affect the operation of the tools. It has been found, for example, that a tool may be functioning properly, except when significant foot traffic occurs adjacent the tool. Vibration from the foot traffic may be sufficient to cause a tool to malfunction. Likewise, air leaks, temperature variations, dust, light and other environmental factors may affect a tool. The tool site database 170 allows the tool location or environmental factors to be taken into account in isolating malfunctions.

Data from the tool site database 170 and test yield data from the test yield database are provided to a statistical evaluation system 190. As will be described in detail below, the statistical evaluation system 190 employs these data to generate analysis-of-means (ANOM)-based representations that allow tool malfunctions to be recognized and isolated to one or a small number of tools. In the illustrated embodiment, the ANOM representations are comprehensive and common to a wide variety of tool types, able to isolate potential malfunctions through a known, statistical rate of error and straightforward to understand and interpret, such that a wide variety of people, including those with no formal statistical expertise, can make sense of and act on them.

ANOM was first used in 1967 (see, Ott, “Analysis of Means—A Graphical Procedure,” Industrial Quality Control, volume 24, pages 101-109 (1967), reprinted in, Journal of Quality Technology, volume 15, pages 10-18 (1983)), but has gained popularity recently because it provides a simple graphical interpretation of statistical analysis. ANOM is relatively straightforward to represent graphically and therefore interpret. ANOM is a formal test of a hypothesis. That hypothesis is that differences exist between the equivalent tools being tested. The null hypotheses is therefore that no differences exist between those equivalent tools. ANOM employs upper and lower decision limits (α), which are set at specific significance levels, e.g., α may be set at 0.05, 0.01, 0.001 or 0.0001. The significance level indicates the level of certainty that a difference actually exists in one of the equivalent tools if the ANOM indicates the existence of a difference.

ANOM is an alternative to one-way analysis-of-variance (ANOVA) with fixed effects. ANOVA indicates whether or not a statistically significant difference exists among equivalent tools as compared to the grand mean based on a common confidence interval. ANOM, on the other hand, indicates the means and unique confidence intervals for each equivalent tool as well as whether an equivalent tool's (“group”) mean statistically significantly differs from the overall (“grand”) mean.

Each ANOM chart has three components: (1) a group mean, usually plotted as a bar, (2) a grand mean, usually plotted as a central line, and (3) upper and lower decision limits, usually plotted as lines on either side of the grand mean. The grand mean is calculated as follows:

$$\overline{\overline{X}} = \frac{{n}_{1} {\overline{X}}_{1} + … + {n}_{k} {\overline{X}}_{k}}{{n}_{1} + … + {n}_{k}}$$

where Xᵢ are group means and nᵢ are weights.

The formulas for the group and grand means and upper and lower decision limits differ depending upon the characteristics of the test yield data, i.e., groups of test yield data can be balanced or unbalanced, and proportional, continuous and defect/event count data have different statistical distributions.

Three kinds of ANOM charts exist. “P” ANOM charts compare proportions, such as yield and bin percentages, and assume a binomial distribution. “X” ANOM charts compare means, such as unbounded parametrics, and assume a normal distribution. “U” ANOM charts compare rates, such as defect or event counts and bounded parametrics, and assume a Poisson distribution. The invention uses a P ANOM chart as the basis for its ANOM representation.

Assuming that the sample sizes of the randomly selected test yield data are large, the upper and lower decision limits may be calculated with the well-known normal approximation to the binomial distribution. A test of this assumption is that the number of units at the tool multiplied by the yield is greater than 5. For example, 185*0.95=175.75>5 (95% yield). 185 units with a yield of 95% pass this test. On the other hand, 185*0.02=3.7<5 (2% bin 45). 185 units with 2% bin 45s fail this test.

Group sizes are balanced when all groups have the same number of observations. The upper and lower decision limits for balanced group sizes, and assuming a binomial distribution, are:

$$lower decision limit ( LDL ) = max ( \overline{p} - h ( α ; k , n , ∞ ) \sqrt{\overline{p} ( 1 - \overline{p} )} \sqrt{\frac{k - 1}{n k}} , 0 )$$

$$upper decision limit ( UDL ) = min ( \overline{p} + h ( α ; k , n , ∞ ) \sqrt{\overline{p} ( 1 - \overline{p} )} \sqrt{\frac{k - 1}{n k}} , 1 )$$

Group sizes are unbalanced if any group does not have the same number of observations of any other group. The upper and lower decision limits for unbalanced group sizes, and assuming a binomial distribution, are:

$$lower decision limit ( LDL ) = max ( \overline{p} - h ( α ; k , {n}_{1} , … , {n}_{k} , ∞ ) \sqrt{\overline{p} ( 1 - \overline{p} )} \sqrt{\frac{N - {n}_{i}}{N {n}_{i}}} , 0 )$$

$$upper decision limit ( UDL ) = min ( \overline{p} + h ( α ; k , {n}_{1} , … , {n}_{k} , ∞ ) \sqrt{\overline{p} ( 1 - \overline{p} )} \sqrt{\frac{N - {n}_{i}}{N {n}_{i}}} , 1 )$$

Decision limits are different if the groups are not constant.

FIG. 1 also shows the concept of complete distribution. Complete distribution means that the products processed by each tool carrying out a given process are provided to each tool carrying out the next process. Various arrows linking each of the various tools of each process to each of the various tools of each subsequent process illustrate this. For example, the products originating at the origin 110 are provided to each of the six equivalent tools (Tool 1 120a, Tool 2 120b, Tool 3 120c, Tool 4 120d, Tool 5 120e, Tool 6 120f) of Process 1. The products emerging from each of the six equivalent tools of Process 1 are provided to each of the four equivalent tools (Tool 1 130a, Tool 2 130b, Tool 3 130c, Tool 4 130d) of Process 2. The products emerging from each of the four equivalent tools of Process 2 are provided to each of the five equivalent tools (Tool 1 140a, Tool 2 140b, Tool 3 140c, Tool 4 140d, Tool 5 140e) of Process 3. The products emerging from each of the five equivalent tools of Process 3 are provided to each of the three equivalent test tools (Tool 1 150a, Tool 2 150b, Tool 3 150c) of Test A, and so on. The essence of complete distribution is that the test yield data contains data corresponding to every possible permutation of tool from process to process.

Two aspects of a complete distribution should be noted. First, a complete distribution does not require randomness, but merely completeness. A complete distribution may be systematic, e.g., round-robin. Those skilled in the statistical arts understand that randomness reduces bias in sampled data. However, it has been found that random distribution is not only frustrating to carry out in a real-world manufacturing facility, it is also unnecessary to the statistical evaluation of the invention. Instead of requiring the distribution to be random, selection of the test yield data is random. Thus, data bias is reduced by means of its selection rather than its generation.

Second, the distribution need be complete only with respect to those tools that the statistical evaluation system 190 is to evaluate effectively. For example, distributions in certain portions of the production line may not be complete. As a result, the ANOM carried out by the statistical evaluation system 190 may be inadequate to isolate malfunctions satisfactorily or cause false-positives or false-negatives to occur in the evaluation. To counteract this, some embodiments of the invention include a test yield data bias corrector configured to reduce bias caused by a lack of distribution completeness or any other cause.

FIG. 2 illustrates a high-level block diagram of one embodiment of the statistical evaluation system 190 of FIG. 1. The embodiment of FIG. 2 has as its workpiece a semiconductor fabrication facility. The products of a semiconductor fabrication facility are ICs. Those skilled in the art will recognize, however, that the principles of the present invention encompass manufacturing facilities other than semiconductor fabrication facilities.

The particular embodiment of the statistical evaluation system 190 of FIG. 1 includes a random test yield data selector 210. The random test yield data selector 210 is configured to select test yield data on products (e.g., ICs) randomly from the tools associated with the test process. The random selection may, however, be based on tool location as contained and retrieved from the tool site database 170. It will be recalled that the products were subjected to a complete distribution. In the illustrated embodiment, the test yield data is retrieved from the test yield database 180 of FIG. 1.

The statistical evaluation system 190 of FIG. 1 also includes a test yield data bias corrector 220. The test yield data bias corrector 220 is associated with the random test yield data selector 210 and is configured to reduce at least some bias in the test yield data.

As those skilled in the pertinent art understand, ANOM is susceptible to biased data. Bias may be introduced in the production line when products are not completely distributed at each process. For example, if all the products from Process 1, Tool 1 120a are provided to Process 2, Tool 1 130a, ANOM will probably falsely indicate that both Process 1, Tool 1 120a and Process 2, Tool 1 130a may be malfunctioning. Accordingly, ANOM control charts can show false malfunctions due to biased test yield data. Performing multiple ANOMs on test yield data to control for different factors is tedious and time-consuming. Multiple ANOMS also lead to judgment calls about which ANOM more fairly represents actual conditions. For these reasons, the test yield data bias corrector 220 may be used to advantage to reduce any bias that exists in the test yield data.

The test yield data bias corrector 220 may reduce any bias by standardizing test yield numbers or other rates. The test yield numbers may, for example, be standardized across known causes of differences for equivalent tools that behave differently (e.g., have a different throughput or capacity, are from different manufacturers or are of different ages). The test yield numbers may also be standardized by die size, which results in defect density. The test yield data bias corrector 220 may further employ ranking schemes using categories of known causes of differences. Those skilled in the pertinent art understand the various ways in which biases in sampled data may be reduced.

The statistical evaluation system 190 of FIG. 1 further includes a test yield data normalizer 230. The test yield data normalizer 230 is associated with the test yield data bias corrector 220 and is configured to normalize the test yield data. Normalization helps to correct issues that arise when equivalent tools are employed to process multiple products. Well-known normalization techniques such as interquantile range, median absolute deviation or loess model normalization may be used.

The statistical evaluation system 190 of FIG. 1 also includes a group and grand means calculator 240. The group and grand means calculator 240 is associated with the random test yield data selector 230 and is configured to calculate group and grand means for the selected test yield data.

The statistical evaluation system 190 of FIG. 1 further includes an ANOM representation generator 250. The ANOM representation generator 250 is associated with the group and grand means calculator 240 and is configured to generate an ANOM representation of at least one of the plurality of semiconductor fabrication processes by plotting bars for the group means, a line for the grand means and lines for decision limits corresponding to specific significance levels. Examples of these ANOM representations will be illustrated in FIGS. 4 and 5.

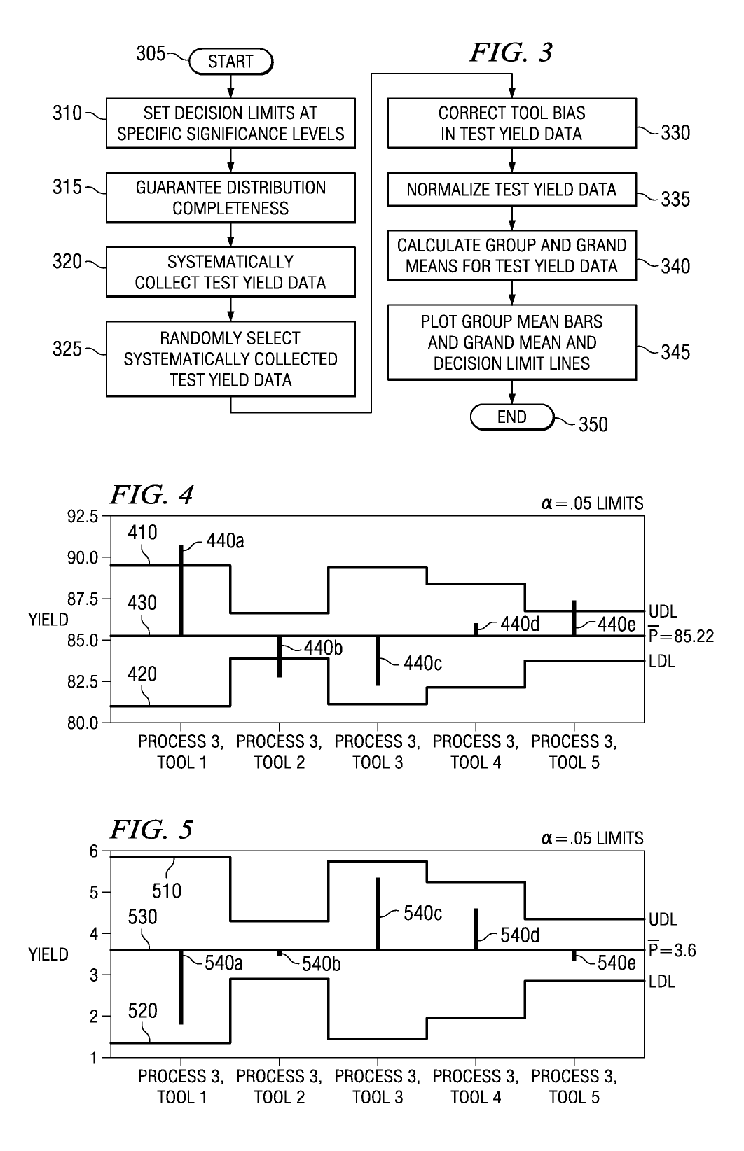

FIG. 3 illustrates a flow diagram of one embodiment of a method of statistically evaluating a manufacturing facility carried out according to the principles of the invention. The method begins in a start step 305 when it is desired to evaluate the performance of a manufacturing facility.

In a step 310, upper and lower decision limits are set at specific significance levels. The upper and lower decision limits indicate whether or not variation in test yield data corresponding to a particular tool is regarded as significant. If the decision limits are set too high, false negatives may result; if the decision limits are set too low, false positives may result. Therefore, the decision limits may be set empirically at an optimal level based on experience with a particular type of tool and their related population or sample sizes. Those skilled in the pertinent art are familiar with the relationship between the population size or sample size and tests of statistical significance.

In a step 315, distribution completeness is guaranteed, at least to the extent desired to avoid excess bias with respect to the tools to be evaluated. In a step 320, test yield data are systematically collected and perhaps stored in a test yield database, e.g., the test yield database 180 of FIG. 1. As described above, a complete distribution is needed for tools that are to be evaluated most effectively. However, the distribution does not need to be random; it can be systematic. The test yield data may be expressed in terms of absolute numbers or as fractions (e.g., percentages).

In a step 325, test yield data on products subjected to a complete distribution are randomly selected from the tools associated with the test process. The selection may be random with respect to the entire population of test yield data or with respect to stratified subsets of test yield data. Those skilled in the pertinent art understand various random sampling techniques, all of which fall within the scope of the invention. In a step 330, the collected test yield data may be corrected for tool bias as described above. In a step 335, the test yield data may be normalized.

In a step 340, group and grand means are calculated for the selected test yield data. The group and grand means may be calculated as described above.

In a step 345, an ANOM representation of at least one of the plurality of processes is generated by plotting the group and grand means and decision limits corresponding to specific significance levels. FIGS. 4 and 5 set forth example ANOM representations. The ANOM representation may include tool site or other environmental data retrieved from a tool site database, e.g., the tool site database 170 of FIG. 1.

Once generated, the ANOM representation, together with any ANOM representations generated with respect to others of the plurality of processes, may then be presented on a computer display device (perhaps accessible at a web site), printed out on paper or delivered in any conventional or later-developed way to those responsible for inspecting and repairing any malfunctioning tools that the ANOM representation may indicate. The method ends in an end step 350.

FIG. 4 illustrates one embodiment of an ANOM representation of at least one of a plurality of processes in which at least one possible tool malfunction is indicated. In FIG. 4, the process in question is Process 3, which has five equivalent tools (Tool 1 140a, Tool 2 140b, Tool 3 140c, Tool 4 140d and Tool 5 140e of FIG. 1). α is set at 0.05, indicating a confidence level of 95% and resulting in upper and lower decision limits 410, 420, which are plotted as lines on either side of a grand mean 430. The grand mean 430 is also plotted as a line. Group means 440a, 440b, 440c, 440d, 440e are plotted as vertical bars and correspond to Tool 1, Tool 2, Tool 3, Tool 4 and Tool 5.

The distance between the upper and lower decision limits for each equivalent tool varies inversely as a function of the number of samples of test yield data taken of product from that tool. For example, the distance is greater for Tool 1 than for Tool 2, indicating that Tool 2 has a greater number of samples. The length of the group mean bar for each equivalent tool varies directly as a function of the variation in the samples of test yield data taken of product from that tool. For example, the height of the bar of the group mean 440a is greater than that of the bar of the group mean 440d, indicating that Tool 1 has a greater variation in its output.

If any bar extends above its upper decision limit 410 or under its lower decision limit 420, the specified degree of confidence exists that the corresponding tool is malfunctioning. Consequently, that tool bears inspection. For example, the bar of the group mean 440a extends above the upper decision limit 410; the bar of the group mean 440b extends below the lower decision limit 420; and the bar of the group mean 440e extends above the upper decision limit 410. Tools 1, 2 and 5 bear inspection. Tools 3 and 4 are probably functioning properly.

FIG. 5 illustrates one embodiment of an ANOM representation of at least one of a plurality of processes in which the equivalent tools appear to be functioning properly. In FIG. 5, the process in question is again Process 3, which has five equivalent tools (Tool 1 140a, Tool 2 140b, Tool 3 140c, Tool 4 140d and Tool 5 140e of FIG. 1). α is again set at 0.05, indicating a confidence level of 95% and resulting in upper and lower decision limits 510, 520, which are plotted as lines on either side of a grand mean 530. Group means 540a, 540b, 540c, 540d, 540e again correspond to Tool 1, Tool 2, Tool 3, Tool 4 and Tool 5. FIG. 5 shows that all five group means 540a, 540b, 540c, 540d, 540e fall between the upper and lower decision limits 510, 520. Thus, all five tools of Process 3 appear to be in proper working order.

The ANOM representations of FIGS. 4 and 5 may employ color to advantage. For example, the area between the upper and lower decision limits may be colored differently than the areas on either side of the upper and lower decision limits. The bars representing the group means may likewise be colored for contrast and perhaps colored based on whether or not they extend above the upper decision limit, extend below the lower decision limit or fall between the upper and lower decision limits.

Although the invention has been described in detail, those skilled in the pertinent art should understand that they can make various changes, substitutions and alterations herein without departing from the scope of the invention in its broadest form.

What is claimed is:

1. For use with a manufacturing facility that carries out a plurality of processes, including a test process, to manufacture products, a plurality of alternative, equivalent tools being associated with each of said plurality of processes, a statistical evaluation system, comprising:
a random test yield data selector configured to select test yield data on products subjected to a complete distribution randomly from said tools associated with said test process;
a group and grand means calculator associated with said random test yield data selector and configured to calculate group and grand means for said selected test yield data; and
an analysis-of-means representation generator associated with said group and grand means calculator and configured to generate an analysis-of-means representation of at least one of said plurality of processes by plotting said group and grand means and decision limits corresponding to specific significance levels.

2. The system as recited in claim 1 further comprising a test yield data bias corrector associated with said random test yield data selector and configured to reduce at least some bias in said test yield data.

3. The system as recited in claim 1 further comprising a test yield data normalizer associated with said group and grand means calculator and configured to normalize said test yield data before said group and grand means calculator calculates group and grand means.

4. The system as recited in claim 1 wherein said plurality of processes comprises semiconductor fabrication processes and said products are integrated circuits.

5. The system as recited in claim 1 wherein a tool site database is associated with said random test yield data selector.

6. The system as recited in claim 1 wherein said test yield data selector receives said test yield data from a test yield database.

7. The system as recited in claim 1 wherein said plurality of processes includes a plurality of test processes and said random test yield data selector is configured to select test yield data on products subjected to a complete distribution randomly from said tools associated with each of said plurality of test processes.

8. For use with a manufacturing facility that carries out a plurality of processes, including a test process, to manufacture products, a plurality of alternative, equivalent tools being associated with each of said plurality of processes, a method of statistically evaluating said manufacturing facility, comprising:
selecting test yield data on products subjected to a complete distribution randomly from said tools associated with said test process;
calculating group and grand means for said selected test yield data; and
generating an analysis-of-means representation of at least one of said plurality of processes by plotting said group and grand means and decision limits corresponding to specific significance levels.

9. The method as recited in claim 8 further comprising reducing at least some bias in said test yield data before said calculating.

10. The method as recited in claim 8 further comprising normalizing said test yield data before said calculating.

11. The method as recited in claim 8 wherein said plurality of processes comprises semiconductor fabrication processes and said products are integrated circuits.

12. The method as recited in claim 8 further comprising storing tool site data in a tool site database.

13. The method as recited in claim 8 further comprising storing said test yield data in a test yield database.

14. The method as recited in claim 8 wherein said plurality of processes includes a plurality of test processes and said selecting is carried out with respect to each of said plurality of test processes.

15. For use with a semiconductor fabrication facility that carries out a plurality of semiconductor fabrication processes, including a test process, to manufacture integrated circuits, a plurality of alternative, equivalent tools being associated with each of said plurality of semiconductor fabrication processes, a statistical evaluation system, comprising:
a random test yield data selector configured to select test yield data on integrated circuits subjected to a complete distribution randomly from said tools associated with said test process;
a test yield data bias corrector associated with said random test yield data selector and configured to reduce at least some bias in said test yield data;
a test yield data normalizer associated with said test yield data bias corrector and configured to normalize said test yield data;
a group and grand means calculator associated with said random test yield data selector and configured to calculate group and grand means for said selected test yield data; and
an analysis-of-means representation generator associated with said group and grand means calculator and configured to generate an analysis-of-means representation of at least one of said plurality of semiconductor fabrication processes by plotting bars for said group means, a line for said grand means and lines for decision limits corresponding to specific significance levels.

16. The system as recited in claim 15 wherein said complete distribution is a systematic distribution.

17. The system as recited in claim 15 wherein a tool site database is associated with said random test yield data selector.

18. The system as recited in claim 15 wherein said test yield data selector receives said test yield data from a test yield database.

19. The system as recited in claim 15 wherein said plurality of semiconductor fabrication processes includes a plurality of test semiconductor fabrication processes and said random test yield data selector is configured to select test yield data on integrated circuits subjected to a complete distribution randomly from said tools associated with each of said plurality of test semiconductor fabrication processes.
